(19) United States
(12) Patent Application Publication
(10) Pub. No.: US 2026/0067692 A1
(43) Pub. Date: Mar. 5, 2026

(54) MANAGING CELLULAR NETWORK COMMUNICATON FOR A DATA PROCESSING SYSTEM WITH A MANAGEMENT CONTROLLER

(71) Applicant: Dell Products L.P., Round Rock, TX (US)

(72) Inventors: BASSEM EL-AZZAMI, Austin, TX (US); ABEYE TESHOME, Austin, TX (US); RICHARD M. TONRY, Georgetown, TX (US); ADOLFO SANDOR MONTERO, Pflugerville, TX (US); MOHIT ARORA, Frisco, TX (US); VINODKUMAR VASUDEV OTTAR, McKinney, TX (US); LUIS ANTONIO VALENCIA REYES, Waxahachie, TX (US); RAJARAVI CHANDRA KOLLARAPU, Allen, TX (US)

(21) Appl. No.: 18/820,698

(22) Filed: Aug. 30, 2024

(51) Int. Cl. H04W 12/08

(52) U.S. Cl. CPC H04W 12/08

(57) ABSTRACT

Methods and systems for managing operation of data processing systems are disclosed. To manage a data processing system of the data processing systems, a management system may obtain a whitelist that may define other entities with which portions of the data processing system (e.g., hardware resources, a management controller, etc.) may be authorized to communicate. The whitelist may be enforced, cooperatively between the management system and a radio access network, to screen communications by the portions of the data processing system.

### FIELD

Embodiments disclosed herein relate generally to managing operation of data processing systems. More particularly, embodiments disclosed herein relate to managing operation of the data processing systems by cooperatively, between a management system and a radio access network, enforcing a whitelist on portions of a data processing system of the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1B show diagrams illustrating a system in accordance with an embodiment.

FIGS. 2A-2B show interaction diagrams in accordance with an embodiment.

FIGS. 3A-3C show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of data processing systems. The data processing systems may provide computer-implemented services to any type and number of other devices and/or users of the data processing systems. The computer-implemented services may include any quantity and type of such services.

While providing the computer-implemented services, a data processing system of the data processing systems may communicate with any number and/or types of other entities (e.g., server systems) to obtain information relevant to operation of portions of the data processing system. The portions of the data processing system may include hardware resources and a management controller hosted by the data processing system.

The management controller may operate independently from the hardware resources and may be distinct from and adapted to manage the hardware resources. Additionally, a network module of the data processing system may be adapted to separately advertise network endpoints for the management controller and the hardware resources so that a server system may communicate with the hardware resources using an in-band communication channel and the management controller using an out-of-band communication channel. The network module may facilitate communications between at least the management controller and the other entities over a radio access network (e.g., a cellular network).

However, the communications may be subject to attacks by malicious entities. For example, malware may be introduced into the data processing system that may allow the malicious entities to access data stored by the data processing system. The attacks may negatively impact the computer-implemented services provided by the data processing system.

To reduce a likelihood that computer-implemented services may be impacted by attacks by malicious entities, a management system may, cooperatively with a radio access network, enforce a whitelist on communications by the portions of the data processing system. The whitelist may define other entities with which the portions of the data processing system are authorized to communicate.

To obtain the whitelist, the management system (e.g., a second data processing system operated by an owner of the first data processing system and used to manage the computer-implemented services provided by the first data processing system) may send a request for the whitelist to an owner management system (e.g., that may host the whitelist relevant to the data processing system and defined by a subject matter expert), generate the whitelist based on a data package obtained based on the portions of the data processing system, and/or any other processes.

The whitelist may include, for example, a first entry for the hardware resources that indicates a portion of typical communication partners for the hardware resources and a second entry for the management controller that indicates a portion of typical communication partners for the management controller.

Once obtained, the whitelist may be provided to the radio access network by the management system. The radio access network may screen communications between the portions of the data processing system and any of the other entities based on the whitelist. By doing so, a communication compliance enforced data processing system may be obtained to provide computer-implemented services that are less likely to be impacted by attacks by malicious entities while communicating with other entities.

Thus, embodiments disclosed herein may provide an improved method for managing operation of a data processing system by using a management system to obtain and enforce a whitelist on communications by the data processing system over a radio access network. By doing so, a likelihood that the data processing system may be subject to unauthorized communications with other entities may be reduced.

In an embodiment, a method for managing operation of data processing systems is provided. The method may include: (i) obtaining, by a management system and from a data processing system of the data processing systems, a whitelist of other entities with which portions of the data processing system are authorized to communicate; (ii) cooperatively enforcing the whitelist on the portions of the data processing system with, at least, a radio access network through which the portions of the data system communicate with the other entities to obtain a communication compliance enforced data processing system, the portions of the data processing system comprising hardware resources adapted to provide the computer implemented services and a management controller distinct from and adapted to manage the hardware resources, and both the hardware resources and the management controller relying on a network module of the data processing system to communicate with the other entities; and (iii) providing computer implemented services using the communication compliance enforced data processing system.

The network module may facilitate communications over the radio access network through which at least the management controller communicates with other management systems, the other management systems comprising at least one management system operated by an owner of the data processing system and used to manage the computer implemented services provided by the data processing system.

The communication compliance enforced data processing system may be adapted to send communication to any of the other entities while the radio access network screens communications between the data processing system and other entities using the whitelist.

Obtaining the whitelist may include: (i) sending, by the management system and to an owner management system, a request for the whitelist; and (ii) obtaining, by the management system and from the owner management system, the whitelist as a response to the request.

The whitelist may be defined by a subject matter expert.

Obtaining the whitelist may also include: (i) obtaining, by the management system, a data package based on the data processing system; and (ii) generating, by the management system, the whitelist using the data package.

The data package may include: (i) a first network endpoint for the hardware resources; and (ii) a second network endpoint for the management controller.

The data package may also include: (i) a first list of functionalities provided by the hardware resources; and (ii) a second list of functionalities provided by the management controller.

The data package may also include: (i) a first list of applications hosted by the hardware resources; and (ii) a second list of applications hosted by the management controller.

The data package may also include: a device type identifier for the data processing system.

Generating the whitelist may include: (i) identifying, by the management system and using the data package, typical communication partners; and (ii) adding a first entry to the whitelist for the hardware resources that indicates a portion of the typical communication partners; and (iii) adding a second entry to the whitelist for the management controller that indicates a second portion of the typical communication partners.

The data processing system may include the hardware resources and the network module adapted to separately advertise network endpoints for the management controller and the hardware resources, the network endpoints being usable by a remote entity to address communications to the hardware resources using an in-band communication channel and the management controller using an out-of-band communication channel.

The management controller and the network module may be on separate power domains from the hardware resources so that the management controller and the network module are operable while the hardware resources are inoperable.

The out-of-band communication channel may run through the network module, and an in-band communication channel that services the hardware resources may also run through the network module.

The network module may host a transmission control protocol/internet protocol (TCP/IP) stack to facilitate network communications via the out-of-band communication channel.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

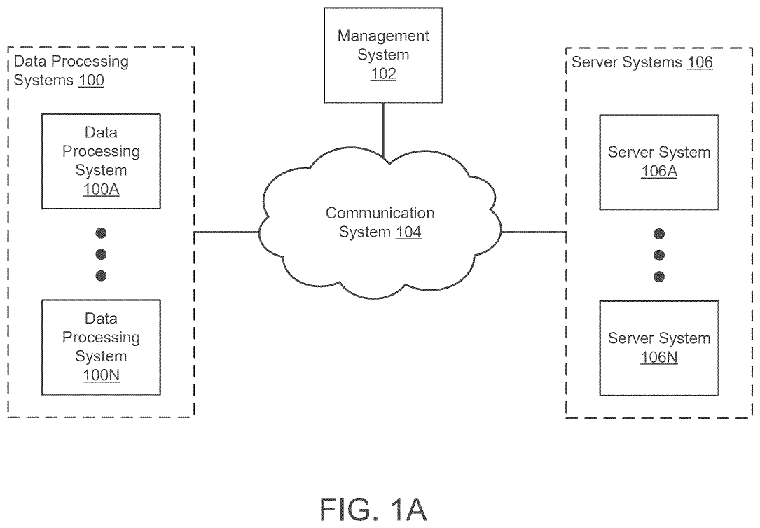

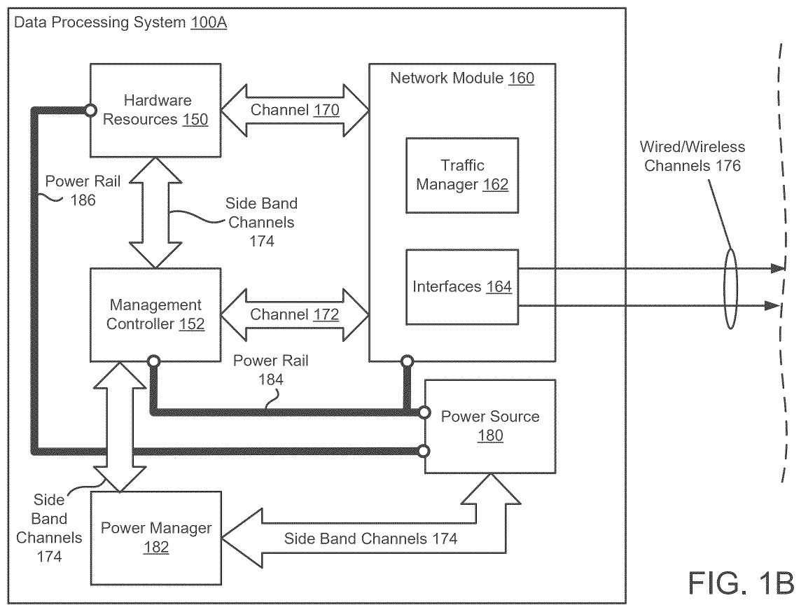

Turning to FIG. 1A, a block diagram illustrating a system in accordance with an embodiment is shown. The system shown in FIG. 1A may provide for management of data processing systems that may provide, at least in part, computer-implemented services (e.g., to user of the system and/or devices operably connected to the system).

The system may include any number of data processing systems 100 (e.g., computing devices) that may each include any number of hardware components (e.g., processors, memory modules, storage devices, communication devices, etc.). The hardware components may support execution of any number and types of applications (e.g., software components). Changes in available functionalities of the hardware and/or software components may provide for various types of different computer-implemented services to be provided over time. Refer to FIG. 1B for additional details regarding data processing systems 100.

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, management system 102, server systems 106, and/or any other type of devices (not shown in FIG. 1A). Other types of computer-implemented services may be provided by the system shown in FIG. 1A without departing from embodiments disclosed herein.

The computer-implemented services may be cooperatively provided by at least the components shown in FIG. 1A. To cooperatively provide the computer-implemented services, the components shown in FIG. 1A may interact, for example, by communicating information over a network (e.g., a radio access network). For example, a data processing system (e.g., 100A) of data processing systems 100 may communicate with server systems 106 to obtain information relevant to operation of portions of data processing system 100A. The portions of data processing system 100A may include hardware resources and a management controller.

The management controller may operate independently from the hardware resources and may be distinct from and adapted to manage the hardware resources. Additionally, data processing system 100A may host a network module adapted to separately advertise network endpoints for the management controller and the hardware resources so that a server system (e.g., 106A) of server systems 106 may communicate with the hardware resources using an in-band communication channel and the management controller using an out-of-band communication channel. The network module may facilitate communications between at least the management controller and the other entities over the radio access network (e.g., a cellular network).

However, the communications may be subject to attacks by malicious entities. For example, malware may be introduced into at least a portion of the data processing system (e.g., the network module) that may allow a malicious entity to access sensitive data stored by data processing system 100A and/or transmit the sensitive data to a server system of server systems 106 that may be operated by the malicious entity. The attacks may negatively impact the computer-implemented services provided by the data processing system.

In general, embodiments disclosed herein relate to systems, devices, and methods for managing operation of data processing systems. To manage the operation of data processing systems for secure communications with other entities (e.g., server systems 106), a management system may, cooperatively with the radio access network, enforce a whitelist on communications by the portions of the data processing system. The whitelist may define the other entities with which the portions of the data processing system are authorized to communicate.

To obtain the whitelist, management system 102 may receive the whitelist in response to a request to an owner management system. The owner management system may include, for example, a second data processing system (e.g., an onboarding system) that may host a whitelist relevant to data processing system 100A and defined by a subject matter expert. Additionally and/or alternatively, management system 102 may obtain the whitelist by generating the whitelist based on a data package obtained based on the portions of data processing system 100A, and/or any other processes.

To obtain the data package, management system 102 may receive, from data processing system 100A, the data package that may include, for example, the network endpoints for the hardware resources and the management controller, lists of functionality provided by the hardware resources and the management controller, lists of applications hosted by the hardware resources and the management controller, a device type identifier for data processing system 100A, and/or any other information.

Management system 102 may subsequently generate the whitelist by identifying typical communication partners based on the data package. For example, based on a first list of applications hosted by the hardware resources of data processing system 100A, management system may perform a lookup in a repository to identify a portion of typical communication partners that each application of the first list of applications may communicate with to support a functionality of the each application. Management system 102 may perform a similar process based on a second list of applications hosted by the management controller of data processing system 100A to identify a second portion of typical communication partners for the management controller.

By generating the whitelist, management system 102 may provide the whitelist to the radio access network. The radio access network may screen communications between the portions of data processing system 100A and any of the other entities (e.g., server systems 106) based on the whitelist. By doing so, a communication compliance enforced data processing system may be obtained to provide computer-implemented services that are less likely to be impacted by attacks by malicious entities while communicating with the other entities.

To provide the above noted functionality, the system may include data processing systems 100, management system 102, and server systems 106. Each of these components is discussed below.

Data processing systems 100 may include any number of data processing systems (e.g., 100A-100N) that may individually and/or cooperatively provide at least a portion of the computer-implemented services. Any of data processing systems 100 may include in-band components (e.g., hardware resources), out-of-band components (e.g., management controller, network modules, etc.), and functionality that may allow the out-of-band components to communicate with management system 102 and/or server systems 106 via an out-of-band communication channel.

While providing the at least a portion of the computer-implemented services, a data processing system (e.g., 100A) of data processing systems 100 may communicate with and/or obtain network communications server systems 106 and/or management system 102. For example, the network communications may include requests and/or data usable to support a functionality of an application hosted by hardware resources of data processing system 100A. Additionally, hardware resources hosted by data processing system 100A may typically communicate with a first portion of server systems 106 and a management controller hosted by data processing system 100A may typically communicate with a second portion of server systems 106 and/or management system 102.

Management system 102 may, as discussed above, provide remote management services. Management system 102 may include, for example, a second data processing system operated an owner of data processing systems 100. To provide the remote management services, management system 102 may interact with data processing systems 100 to obtain and/or provide information (e.g., data) relevant to operation of data processing systems 100. For example, management system 102 may send a request to a data processing system (e.g., 100A) of data processing systems 100 to receive a data package (e.g., information regarding network endpoints, functionalities, applications hosted by data processing system 100A, etc.). Once obtained, management system 102 may generate a whitelist (e.g., a list of entities with which data processing system 100A may be authorized to communicate), and cooperatively with a radio access network of communication system 104, enforce the whitelist on communications by data processing system 100A.

Additionally, management system 102 may obtain information (e.g., from the radio access network) regarding unauthorized activity by data processing system 100A. For example, if data processing system 100A attempts to communicate with an unauthorized entity (e.g., to transmit sensitive data to a potentially malicious entity), management system 102 may receive a report indicating the unauthorized activity from the radio access network. Management system 102 may subsequently perform management actions based on the unauthorized activity. For example, management system 102 may suspend network communications by data processing system 100A, issue commands to depower data processing system 100A (e.g., via the management controller of data processing system 100A), and/or perform any other actions to reduce a vulnerability of data processing system 100A.

Server systems 106 may, as discussed above, provide resource sharing services. To provide the resource sharing services, server systems 106 may communicate with data processing systems 100 over a network (e.g., a radio access network). For example, server systems 106 may host resources (e.g., data, storage, computational resources, remote services, etc.) that may be requested by data processing systems 100 to support operation of data processing systems 100. To provide a desired portion of the resources, an authorized server system (e.g., 106A) of server systems 106 may receive a request from a data processing system (e.g., 100A) of data processing systems 100.

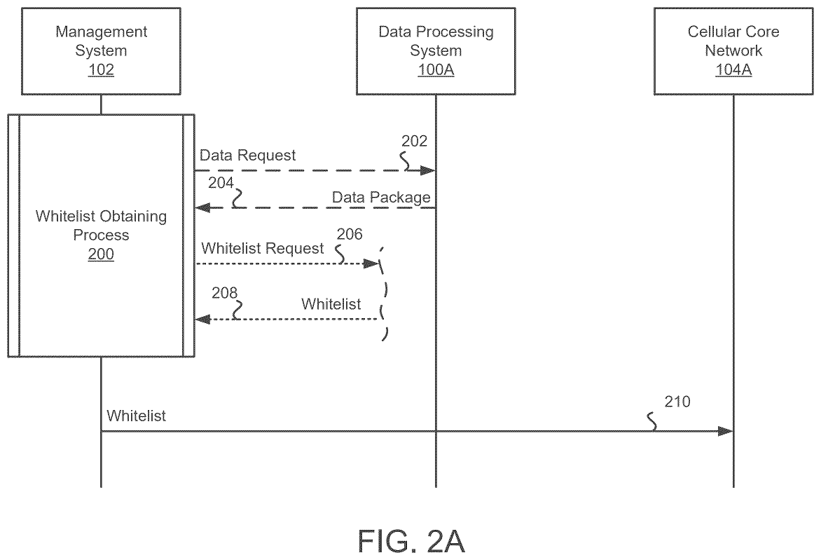

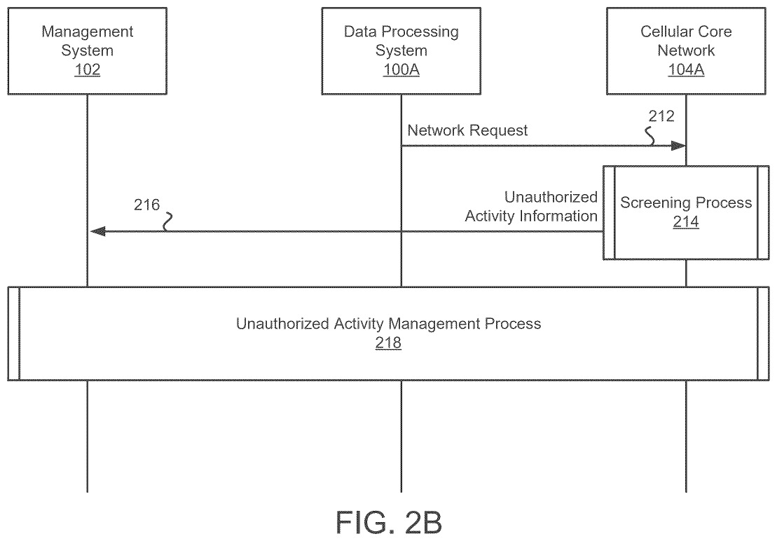

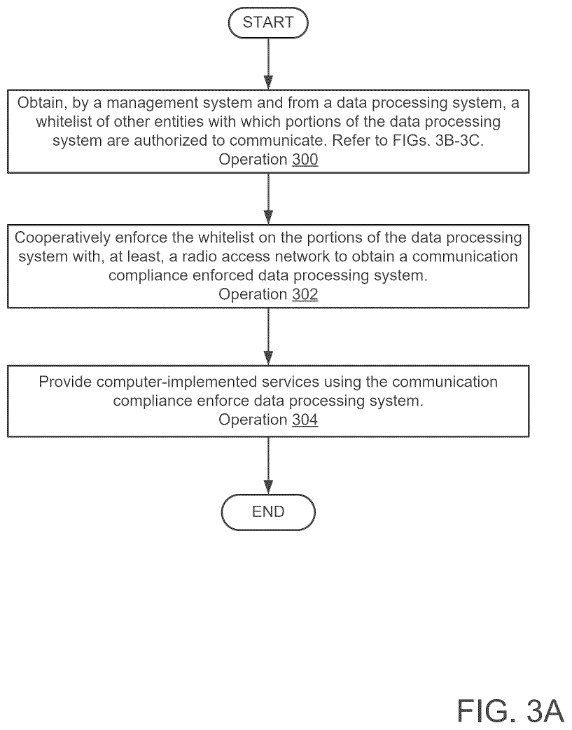

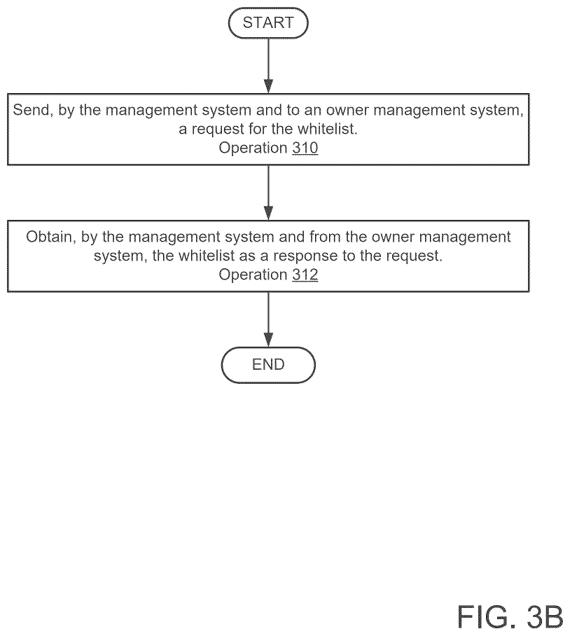

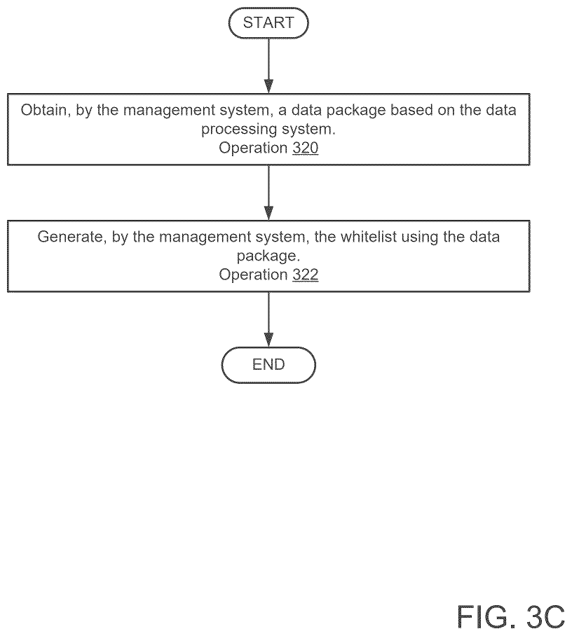

While providing their functionality, any of data processing systems 100, management system 102, and/or server systems 106 may provide all or a portion of the methods shown in FIGS. 2A-3C.

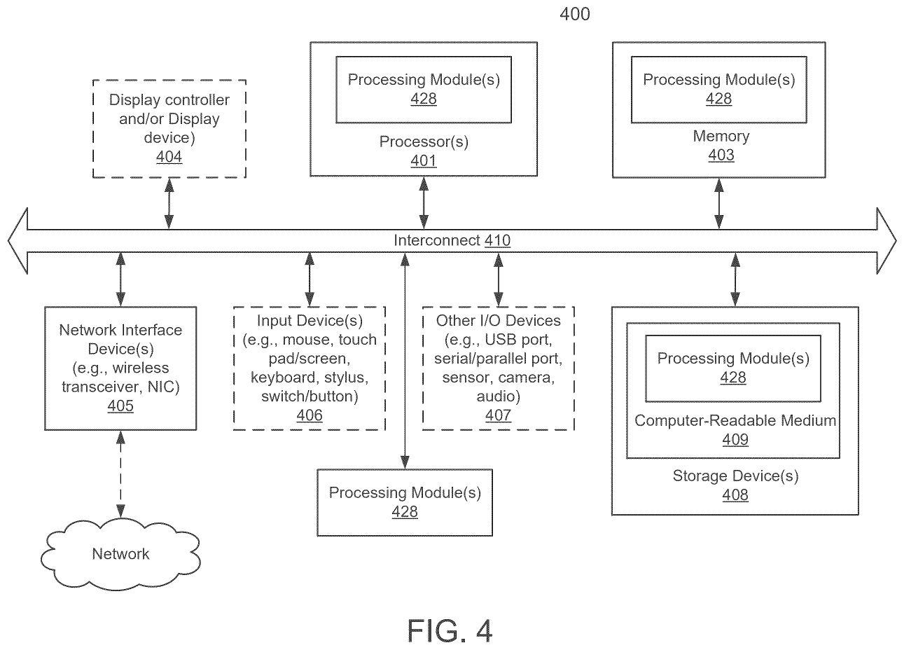

Communication system 104 may allow any of data processing systems 100, and management system 102 to communicate with one another (and/or with other devices not illustrated in FIG. 1A). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to management system 102 and/or server systems 106 via the Internet. Data processing systems 100, management system 102, and/or communication system 104 may be adapted to perform one or more protocols for communicating via communication system 104.

Any of (and/or components thereof) data processing systems 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1A, a system in accordance with an embodiment may process network communications for a data processing system of data processing systems 100 by reconfiguring a flow of network communication obtained from a management system to be screened by a management controller of the data processing system. By doing so, the management controller may identify an action set to perform to update operation of the data processing system.

While illustrated in FIG. 1A with a limited number of specific components, a system may include additional, fewer, and/or different components without departing from embodiments disclosed herein.

Turning to FIG. 1B, a diagram illustrating a data processing system in accordance with an embodiment is shown. Data processing system 100A shown in FIG. 1B may be similar to any of the data processing systems shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing hardware resources 150 to communicate with other devices via packet switched networks and/or other types of communication networks.

The processor may also host various applications that provide the computer-implemented services. The applications may utilize various services provided by the management entities and use (at least indirectly) the network stack to communication with other entities.

However, use of the network stack and the services provided by the management entities may place the applications at risk of indirect compromise. For example, if any of these entities trusted by the applications are compromised, these entities may subsequently compromise the operation of the applications. Additionally, if various drivers and/or the communication stack are compromised, communications to/from other devices may be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100A) to another device via any number of intermediate networks (e.g., via wired/wireless channels 176 that are part of the networks).

To reduce the likelihood of the applications and/or other in-band entities from being indirectly compromised, data processing system 140 may include management controller 152 and network module 160. Each of these components of data processing system 140 is discussed below.

Management controller 152 may be implemented, for example, using a system on a chip or other type of independently operating computing device (e.g., independent from the in-band components, such as hardware resources 150, of a host data processing system 100A). Management controller 152 may provide various management functionalities for data processing system 100A. For example, management controller 152 may monitor various ongoing processes performed by the in-band component, may manage power distribution, thermal management, and/or other functions of data processing system 100A.

To do so, management controller 152 may be operably connected to various components via sideband channels 174 (in FIG. 1B, a limited number of sideband channels are included for illustrative purposes, it will be appreciated that management controller 152 may communication with other components via any number of sideband channels). The sideband channels may be implemented using separate physical channels, and/or with a logical channel overlay over existing physical channels (e.g., logical division of in-band channels). The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, management controller 152 may obtain information regarding a device type identifier for data processing system 100A, functionalities provided by management controller 152 and/or hardware resources 150, lists of applications hosted by management controller 152 and/or hardware resources 150, and/or any other information. Management controller 152 may also interact with management system 102, for example, by providing the information to management system 102 for using in generating a whitelist of typical communication partners of management controller 152 and/or hardware resources 150.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

To facilitate communication with other devices, data processing system 100A may include network module 160. Network module 160 may provide communication services for in-band components and out-of-band components (e.g., management controller 152) of data processing system. To do so, network module 160 may include traffic manager 162 and interfaces 164.

Traffic manager 162 may include functionality to (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, that may independently addressable, and otherwise unrelated to one another.

However, network module 160 may be subject to attacks by malicious entities. For example, malicious code (e.g., malware) may be introduced to network module 160 via communications that traverse network module 160. The malicious code may negatively impact an ability of network module 160 to direct communications between portions of data processing system 100A (e.g., management controller 152, hardware resources 150, etc.) to authorized entities.

To reduce an impact of the attacks on network module 160 (and/or other portions of data processing system 100A), a whitelist of authorized entities may be enforced, cooperatively between management system 102 and a radio access network.

To facilitate management of data processing system 100A over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations illustrated in FIGS. 2A-3C.

While illustrated in FIG. 1B with a limited number of specific components, a system may include additional, fewer, and/or different components without departing from embodiments disclosed herein.

To further clarify embodiments disclosed herein, interaction diagrams in accordance with an embodiment are shown in FIGS. 2A-2B. The interaction diagrams may illustrate how data may be obtained and used within the system of FIGS. 1A-1B.

In the interaction diagrams, processes performed by and interactions between components of a system in accordance with an embodiment are shown. In the diagrams, components of the system are illustrated using a first set of shapes (e.g., 102, 100A, etc.), located towards the top of each figure. Lines descend from these shapes. Processes performed by the components of the system are illustrated using a second set of shapes (e.g., 200, 214, etc.) superimposed over these lines. Interactions (e.g., communication, data transmissions, etc.) between the components of the system are illustrated using a third set of shapes (e.g., 202, 204, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 202 may occur prior to the interaction labeled as 204. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur during establishing of a whitelist for a data processing system.

Cellular core network 104A may be a portion of communication system 104 through which data processing system 100A may communicate with other entities (e.g., server systems 106, not shown). Cellular core network 104A may include, for example, a 5G cellular network implemented using a radio access network, a mobile network operator, and/or any other systems that may facilitate network communication between entities.

To establish the whitelist for data processing system 100A, whitelist obtaining process 200 may be performed. During whitelist obtaining process, a whitelist may be obtained by management system 102. To obtain the whitelist, management system 102 may (i) send a request for a whitelist corresponding to data processing system 100A (e.g., that may be defined by a subject matter expert) to an owner management system (refer to interactions 206-208 for additional details), (ii) obtain a data package from data processing system 100A in response to a request for the data package (refer to interactions 202-204 for additional details), (iii) generate a whitelist by identifying typical communication partners of data processing system 100A based on the data package, and/or any other process. By obtaining the whitelist, management system 102 may identify entities with which data processing system 100A may be authorized to communicate.

At interaction 202 (shown in a long-dashed line), a data request may be provided to data processing system 100A by management system 102. For example, the data request may be generated and provided to data processing system 100A by (i) transmitting the data request via a message, (ii) invoking an application interface programming call in a management program interface, and/or performing any other actions. By providing the data request to data processing system 100A, data processing system 100A may provide information regarding network endpoints, functionalities, applications, and/or any other information regarding portions of data processing system 100A (e.g., management controller, and hardware resources) that may be usable to identify typical communication partners for the portions of data processing system 100A.

At interaction 204, a data package may be provided to management system 102 by data processing system 100A. For example, the data package may be generated and provided to management system 102 by (i) transmitting the data package via a message, (ii) storing the data in a storage with subsequent retrieval by management system 102, (iii) participating in a publish-subscribe system where management system 102 subscribes to updates from data processing system 100A thereby causing a copy of the data package to be propagated to management system 102, and/or any other processes. By providing the data package to management system 102, management system 102 may generate a whitelist for data processing system 100A based on at least the data package.

At interaction 206 (shown in a short-dashed line), a whitelist request may be provided to an owner management system by management system 102. The owner management system may include, for example, a second data processing system (not shown) that may be operated by an owner (e.g., an administrator) of data processing systems 100 and/or management system 102. By providing the whitelist request to the owner management system, the owner management system may identify a whitelist of typical communication partners corresponding to portions of data processing system 100A.

At interaction 208, a whitelist may be provided to management system 102 by the owner management system. For example, the whitelist may be generated and provided to management system 102 by (i) performing a lookup in a repository using attributes (e.g., device type identifier, hosted applications, etc.) of the portions of data processing system 100A as keys to obtain a whitelist (e.g., that may be defined by a subject matter expert), (ii) transmitting the whitelist via a message, (iii) storing the data in a storage with subsequent retrieval by management system 102, and/or any other processes.

At interaction 210, the whitelist may be provided to cellular core network 104A by management system 102. For example, the whitelist may be provided to cellular core network 104A via (i) provisioning of a network security policy supported by cellular network 104A, (ii) configuring the whitelist to be implemented in a management interface hosted by cellular network 104A, (iii) transmitting the whitelist to an operator of cellular core network 104A, and/or any other processes. By providing the whitelist to cellular core network 104A, cellular core network 104A may cooperatively, with management system 102, enforce the whitelist on network communications by data processing system 100A over cellular core network 104A. Refer to FIG. 2B for additional details regarding enforcing of the whitelist on data processing system 100A.

Thus, using processes and interactions shown in FIG. 2A, a whitelist of entities with which portions of a data processing system may be authorized to communicate may be obtained by a management system. The whitelist may be provided to a radio access network (e.g., a cellular network) by the management system. By doing so, a security of communications by the data processing system may be improved.

Turning to FIG. 2B, a second interaction diagram in accordance with an embodiment is shown. The second interaction diagram may illustrate processes and interactions that may occur during enforcing of a whitelist on communications by a data processing system.

At interaction 212, a network request may be provided to cellular core network 104A by data processing system 100A. For example, the network request may be generated and provided to cellular core network 104A by (i) initiating a request to establish a connection and/or engage in a transmission protocol with another entity (e.g., a server system of server systems 106), (ii) packaging data into according to the transmission protocol, (iii) transmitting a radio signal including the network request, and/or any other processes.

To screen the network request, screening process 214 may be performed. During screening process 214, cellular core network 104A may process the network request to obtain an authorization result, and perform an action set based on the authorization result. To process the network request, cellular core network 104A may (i) identify a source network endpoint (e.g., an internet protocol address and/or a unique identifier of a portion of data processing system 100A) and a destination network endpoint (e.g., an internet protocol address of a server system) indicated by the network request, (ii) compare the destination network endpoint to the whitelist to obtain an authorization result that may indicate whether the destination network endpoint corresponds to an entity with which the portion of data processing system 100A is authorized to communicate, and/or perform any other actions.

To perform an action set based on the authorization result, cellular core network 104A may (i) reference a network security policy maintained by management, (ii) handle the network request (e.g., route the network request to an appropriate service and/or to the destination network endpoint) if the authorization result indicates that data processing system 100A is authorized to communicate with the remote entity based on the whitelist, (iii) generate unauthorized activity information based on unauthorized activity indicated by the authorization result, and/or perform any other actions.

At interaction 216, unauthorized activity information may be provided to management system 102 by cellular core network 104A. For example, the unauthorized activity information may be generated and provided to management system 102 by (i) logging details of the network request into a report, (ii) transmitting the unauthorized activity information (e.g., the report) to management system 102, and/or any other processes. By providing the unauthorized activity information to management system 102, management system 102 may handle the unauthorized activity.

To handle the unauthorized activity, unauthorized activity management process 218 may be performed. During unauthorized activity management process 218, an action set may be performed to reduce a likelihood of compromise to data processing system 100A. For example, to perform the action set, management system 102 may (i) suspend network communications of data processing system 100A and/or decommission data processing system 100A, (ii) obtain a notification from data processing system 100A based on a prompt from management system 102 (e.g., to receive justification for the network request by data processing system 100A), (iii) update the whitelist based on the notification, and/or perform any other actions.

Thus, using processes and interactions shown in FIG. 2B, a whitelist may be cooperatively enforced, by at least a management system and a radio access network, on network communications of a data processing system. By doing so, a quality of computer-implemented services provided by the data processing system may be improved.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-1B may perform various methods to manage a data processing system. FIGS. 3A-3C illustrate methods that may be performed by the components of the system of FIGS. 1A-1B. In the diagrams discussed below and shown in FIGS. 3A-3C, any of the operations may be repeated, performed in different orders, and/or performed in parallel with or in a partially overlapping in time manner with other operations.

Turning to FIG. 3A, a first flow diagram illustrating a method of managing operation of a data processing system in accordance with an embodiment is shown. The method may be performed, for example, by any of the components of the system of FIGS. 1A-1B, and/or other components not shown therein.

At operation 300, a whitelist may be obtained by a management system. The whitelist may be obtained by: (i) receiving the whitelist corresponding to portions of a data processing system from an owner management system, (ii) generating the whitelist based on the portions of the data processing system, and/or any other processes. Refer to FIGS. 3B-3C for additional details regarding obtaining the whitelist.

At operation 302, the whitelist may be cooperatively enforced by the management system and a radio access network to obtain a communication compliance enforced data processing system. The whitelist may be cooperatively enforced by: (i) implementing a network security policy based on the whitelist, (ii) providing, by the management system and to the radio access network, the whitelist, (iii) screening, by the radio access network, network communications by the data processing system based on the whitelist, and/or any other processes.

At operation 304, computer-implemented services may be provided using the communication compliance enforced data processing system. The computer-implemented services may be provided by: (i) obtaining a request for data from a user of the data processing system, (ii) transmitting a network request based on the request for data to another entity (e.g., a server system) with which the data processing system may be authorized to communicate, (iii) receiving a response from the other entity that may include desired data, (iv) providing the desired data to the user (e.g., by display the data, storing the data in a storage, etc.), and/or performing any other actions.

The method may end following operation 304.

Using the method shown in FIG. 3A, operation of a data processing system may be managed by enforcing a whitelist on portions of the data processing system to obtain a communication compliance enforced data processing system.

Turning to FIG. 3B, a flow diagram illustrating a method of obtaining a whitelist in accordance with an embodiment is shown. The method may be performed, for example, by any of the components of the system of FIGS. 1A-1B, and/or other components not shown therein.

At operation 310, a request for the whitelist may be sent by the management system and to an owner management system. The request may be sent by: (i) packaging information related to the portions of the data processing system, (ii) transmitting the request via message, and/or any other processes.

At operation 312, the whitelist may be obtained by the management system as a response to the request. The whitelist may be obtained by: (i) defining, by a subject matter expert, the whitelist, (ii) receiving the whitelist via a transmission of a message, (iii) retrieving the whitelist from a storage, and/or any other processes.

The method may end following operation 312.

Turning to FIG. 3C, a third flow diagram illustrating a method of generating a whitelist in accordance with an embodiment is shown. The method may be performed, for example, by any of the components of the system of FIGS. 1A-1B, and/or other components not shown therein.

At operation 320, a data package may be obtained by the management system based on the data processing system. The data package may be obtained by: (i) identifying a first network endpoint for hardware resources of the data processing system and a second network endpoint for a management controller of the data processing system, (ii) providing a request to the data processing system for information (e.g., functionality provided by the portions of the data processing system, applications hosted by the data processing system, etc.), (iii) receiving a response from the data processing system, and/or any other processes.

At operation 322, the whitelist may be generated using the data package. The whitelist may be generated by: (i) identifying typical communication partners based on information provided by the data package, (ii) initializing a data structure for the whitelist, (iii) adding a first entry to the whitelist for the hardware resources that indicates a portion of the typical communication partners of the hardware resources and a second entry to the whitelist for the management controller that indicates a second portion of the typical communication partners of the management controller, and/or performing any other actions.

The method may end following operation 322.

Thus, using the methods shown in FIGS. 3A-3C, operation of a data processing system may be managed by enforcing a whitelist on the portions of the data processing system cooperatively, between a management system and a radio access network. By doing so, the portions of the data processing system may communicate with other entities while providing computer-implemented services that may be less vulnerable to attacks by malicious entities.

Any of the components illustrated in FIGS. 1A-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing operation of data processing systems, the method comprising:
obtaining, by a management system and from a data processing system of the data processing systems, a whitelist of other entities with which portions of the data processing system are authorized to communicate;
cooperatively enforcing the whitelist on the portions of the data processing system with, at least, a radio access network through which the portions of the data system communicate with the other entities to obtain a communication compliance enforced data processing system, the portions of the data processing system comprising hardware resources adapted to provide the computer implemented services and a management controller distinct from and adapted to manage the hardware resources, and both the hardware resources and the management controller relying on a network module of the data processing system to communicate with the other entities; and
providing computer implemented services using the communication compliance enforced data processing system.

2. The method of claim 1, wherein the network module facilitates communications over the radio access network through which at least the management controller communicates with other management systems, the other management systems comprising at least one management system operated by an owner of the data processing system and used to manage the computer implemented services provided by the data processing system.

3. The method of claim 1, wherein the communication compliance enforced data processing system is adapted to send communications to any of the other entities while the radio access network screens the communications between the data processing system and other entities using the whitelist.

4. The method of claim 1, wherein obtaining the whitelist comprises:
sending, by the management system and to an owner management system, a request for the whitelist; and
obtaining, by the management system and from the owner management system, the whitelist as a response to the request.

5. The method of claim 4, wherein the whitelist is defined by a subject matter expert.

6. The method of claim 1, wherein obtaining the whitelist comprises:
obtaining, by the management system, a data package based on the data processing system; and
generating, by the management system, the whitelist using the data package.

7. The method of claim 6, wherein the data package comprises:
a first network endpoint for the hardware resources; and
a second network endpoint for the management controller.

8. The method of claim 7, wherein the data package further comprises:
a first list of functionalities provided by the hardware resources; and
a second list of functionalities provided by the management controller.

9. The method of claim 7, wherein the data package further comprises:
a first list of applications hosted by the hardware resources; and
a second list of applications hosted by the management controller.

10. The method of claim 7, wherein the data package further comprises:
a device type identifier for the data processing system.

11. The method of claim 7, wherein generating the whitelist comprises:
identifying, by the management system and using the data package, typical communication partners; and
adding a first entry to the whitelist for the hardware resources that indicates a portion of the typical communication partners; and
adding a second entry to the whitelist for the management controller that indicates a second portion of the typical communication partners.

12. The method of claim 1, wherein the data processing system comprises the hardware resources and the network module adapted to separately advertise network endpoints for the management controller and the hardware resources, the network endpoints being usable by the management system to address communications to the hardware resources using an in-band communication channel and the management controller using an out-of-band communication channel.

13. The method of claim 12, wherein the management controller and the network module are on separate power domains from the hardware resources so that the management controller and the network module are operable while the hardware resources are inoperable.

14. The method of claim 12, wherein the out-of-band communication channel runs through the network module, and an in-band communication channel that services the hardware resources also runs through the network module.

15. The method of claim 12, wherein the network module hosts a transmission control protocol/internet protocol (TCP/IP) stack to facilitate network communications via the out-of-band communication channel.

16. A non-transitory machine-readable medium having instructions stored therein, which when executed by a processor, cause the processor to perform operations for managing operation of data processing systems, the operations comprising:
obtaining, by a management system and from a data processing system of the data processing systems, a whitelist of other entities with which portions of the data processing system are authorized to communicate;
cooperatively enforcing the whitelist on the portions of the data processing system with, at least, a radio access network through which the portions of the data system communicate with the other entities to obtain a communication compliance enforced data processing system, the portions of the data processing system comprising hardware resources adapted to provide the computer implemented services and a management controller distinct from and adapted to manage the hardware resources, and both the hardware resources and the management controller relying on a network module of the data processing system to communicate with the other entities; and
providing computer implemented services using the communication compliance enforced data processing system.

17. The non-transitory machine-readable medium of claim 16, wherein the network module facilitates communications over the radio access network through which at least the management controller communicates with other management systems, the other management systems comprising at least one management system operated by an owner of the data processing system and used to manage the computer implemented services provided by the data processing system.

18. The non-transitory machine-readable medium of claim 16, wherein the communication compliance enforced data processing system is adapted to send communications to any of the other entities while the radio access network screens the communications between the data processing system and other entities using the whitelist.

19. A data processing system, comprising:
a processor; and
a memory coupled to the processor to store instructions, which when executed by the processor, cause the processor to perform operations for managing operation of data processing systems, the operations comprising:
obtaining, by a management system and from a data processing system of the data processing systems, a whitelist of other entities with which portions of the data processing system are authorized to communicate;
cooperatively enforcing the whitelist on the portions of the data processing system with, at least, a radio access network through which the portions of the data system communicate with the other entities to obtain a communication compliance enforced data processing system, the portions of the data processing system comprising hardware resources adapted to provide the computer implemented services and a management controller distinct from and adapted to manage the hardware resources, and both the hardware resources and the management controller relying on a network module of the data processing system to communicate with the other entities; and
providing computer implemented services using the communication compliance enforced data processing system.

20. The data processing system of claim 19, wherein the network module facilitates communications over the radio access network through which at least the management controller communicates with other management systems, the other management systems comprising at least one management system operated by an owner of the data processing system and used to manage the computer implemented services provided by the data processing system.
